(19) United States
(12) Patent Application Publication
(10) Pub. No.: US 2002/0103850 A1
(43) Pub. Date: Aug. 1, 2002

(54) System and method for out-sourcing the functionality of session initiation protocol (SIP) user agents to proxies

(76) Inventors: Stanley L. Moyer, Mendham, NJ (US); David J. Marples, Mansfield (GB); Simon Tsang, Jersey City, NJ (US)

Correspondence Address: Joseph Giordano, Esq., Telcordia Technologies, Inc., 445South Street, Room IG-112R, Morristown, NJ, 07960, US

(21) Appl. No.: 09/774,964

(22) Filed: Jan. 31, 2001

(51) Int. Cl. G06F 15/16

(52) U.S. Cl. 709/202; 709/230

(57) ABSTRACT

Session Initiation Protocol (SIP) is used to communicate with Network-capable appliances. In a system employing SIP, a remote user agent client (UAC) sends a message over the Internet via a Proxy server to a user agent server at the location of the appliances, e.g., the client's home. This communications channel allows the client to control the appliances and to determine their status. The Proxy server between the UAC and a plurality of UAS processors has the address mapping, authentication, authorization and/or translation functions out-sourced from the UAS processors to the Proxy server connected to them.

### CROSS-REFERENCE TO RELATED APPLICATIONS

This application is related to commonly owned U.S. patent application Ser. No. ______ (Attorney Docket APP 1357) filed concurrently herewith and entitled “System and Method For using Session Initiation Protocol (SIP) to Communicate with Networked Appliances.”

### BACKGROUND OF THE INVENTION

This invention relates to the communication of control signals and status signals over a network to effect operation of networked devices and, more particularly, to the use of Session Initiation Protocol to improved communications with a plurality of networked units.

The Internet Engineering Task Force (“IETF”) has developed a communications protocol called Session Initiation Protocol (“SIP”) which can accommodate a number of different modes of communication. SIP, according to proposed standard RFC 2543, is an application-layer control and signaling protocol for creating, modifying and terminating interactive communications sessions between one or more participants. It is a text-based protocol similar to HTTP and SMTP. These sessions may include voice, video, chat, interactive games and virtual reality, e.g., Internet multimedia conferences, Internet telephone calls and multimedia distribution. Members in a session can communicate via multicast or via a mesh of unicast relations, or a combination of these.

SIP invitations (i.e., the SIP method INVITE) are used to create sessions. These invitations can carry session descriptions which allow participants to agree on a set of compatible media types. SIP supports user mobility by proxying and redirecting requests to the user's current location, which the user can register. SIP is not tied to any particular conference control protocol, but instead it is designed to be independent of the lower-layer transport protocol.

The SIP architecture includes user agents, where a user agent is a device running an application program that can act as both a user agent client (“UAC”) and a user agent server (“UAS”). A client is an application program that sends SIP requests. A client may or may not interact directly with a human user.

A server is an application program that accepts requests from a client in order to service those requests and sends back responses to those requests. Thus, a UAS is a server application that contacts the user when a SIP request is received and that returns a response on behalf of the user. The response accepts, rejects or redirects the request.

In addition there are servers which are not User Agents. These can be Proxy, Redirect or Registrar servers. A Proxy server is an intermediary program that acts as both a server and a client for the purpose of making requests on behalf of other clients. Requests are serviced internally by the Proxy server or are passed by it to other servers, possibly after translation. A Proxy server interprets, and, if necessary, rewrites a request message before forwarding it. In an Internet context, the Proxy server receives requests from a UAC, even when directed to a host with a different URL. After processing, it sends these on to the destination URL.

A Redirect server is a server that accepts a SIP request, maps the address into zero or more new addresses and returns these addresses to the client. Unlike a UAC, it does not initiate its own SIP request. Unlike a UAC, it does not accept calls.

A Registrar server is a server that accepts REGISTER requests. It keeps a list of the registered addresses it receives for the UAS devices in its area and is typically co-located with a Proxy or Redirect server so it can share its information with them.

In a SIP configuration the UAC sends a request to a UAS via one or more Proxy servers. Typically one UAC may address or be capable of addressing multiple UASs. Further, in a standard SIP architecture, endpoints, i.e., UASs, are always able to communicate directly with each other. Applying this structure to a typical multimedia conference, the control application would act as a UAC to initiate calls or to invite others to conferences and it would act as a UAS to accept invitations. The role of UAC and UAS as well as Proxy and Redirect servers are defined on a request-by-request basis. For example, the user agent initiating a call acts as a UAC when sending the initial INVITE request and as a UAS when receiving a BYE request from the device called. Similarly, the same software can act as a Proxy server for one request and as a Redirect server for the next request. The SIP UAS will typically be embedded in SIP phones, PCs and PDAs. These UAS devices are responsible for authenticating the originator of the message and then determining if that entity is authorized to perform the requested operation (typically by consulting an access control list).

The remote control of appliances networked together is a new and growing area of interest. In a typical embodiment, a home can have all or many of its appliances connected to a network. With such a system, the homeowner can access the network and turn on the lights in the driveway, start the coffee maker, and raise or lower the temperature in the home, even before leaving the office. Also, the refrigerator can keep an inventory of your groceries and re-order when necessary. A clock can co-ordinate the user's agenda or perhaps turn on an appliance. To achieve this functionality, it is clear that these appliances need to communicate with each other so that, for example, the alarm clock can turn on the bedroom lamp.

Networked Appliances (NAs) are dedicated consumer devices containing at least one networked processor. As an alternative, conventional appliances can be connected to an appliance controller which accepts remote messages and controls the appliance in the desired way. As a result, a substantial amount of computing power is need in each controller.

In Networked Appliance systems there can be the following considerations that need to be accommodated when considering communication outside of the home, notably:

Security—In-home communication exploits a level of physical security that is lost when arbitrary access from outside of it is permitted.

Authentication—The entity trying to enter into the home needs to be unambiguously identified prior to permitting access.

Reliability—Because of the wide-area nature of extra-home access, there are more points of failure. The home should continue to operate independently of external systems when communication with them is lost.

Scaling—there are very many homes.

Protocol Independence—Although within a single home it is acceptable that many different protocols are used for inter-device communication, a much more protocol-independent approach is required for the wide area, since the exact details of the devices comprising the in-home network may not be known from the outside world.

Naming and Location—Devices within the home need to be unambiguously named and their location identified from outside of it.

Techniques are being developed to begin to allow control of devices in the home from the outside world, most notably by the Open Services Gateway Initiative (OSGi). See OSGi, www.osgi.org. However, this prior system still does not address the general problem of wide area access and security, as well as the other concerns expressed above. These systems do not provide a uniform protocol for communication over the Internet. In addition, these systems require a great deal of functionality at each controllable appliance or a separate appliance controller connected to the Networked Appliance.

There are certain features of the SIP architecture that suggest that it might be useful for communications with Networked Appliances, but with more general applicability to any networked device in which the location phase and communication (or action) phases are merged into a single activity. In particular, SIP allows mobility, i.e., a recipient device can be moved so long as it is registered again at its new location.

SIP is a transactional service, consisting of sequences of request-response transactions within a common context (identified by the Call-ID). This would also apply to a Networked Appliance connection where a conversation (session) is initiated by a first message and the responses and other messages are to be grouped together. Further, SIP uses MIME for transport of content. Thus, the meaning and purpose of the content depend on the request method and on the content type. SIP uses numerous header fields for identification of the users involved in the communication. This function would be useful in Networked Appliance connections. Further, SIP has authentication tools and security mechanisms that are necessary for Networked Appliance systems that allow remote access.

Importantly, in a Networked Appliance system with access from outside the home, a requesting agent must send an instruction to perform an action on a named object in a message. The message would contains the name of the object upon which the action should be performed as its address, and the action itself as the payload. This message would be routed from agent to agent, resolving the name as it goes along. For example, the command “Switch on the lamp in the master bedroom in Dave's house” would first be routed to the server that knows the location of Dave's house. Then the message would be routed on to the firewall device at Dave's house, where access control and authorization is performed. If this is successful, the message payload is then delivered to the device to perform whatever action has been requested.

In SIP this routing by name function is achieved in the INVITE process. In particular, an INVITE is sent first to an agent, or proxy, for the name. The Proxy can rewrite the name and relay the INVITE, getting closer to the eventual destination for the message and delivering the payload (which is conventionally in a Session Description Protocol (SDP)) once it arrives. The processes for locating the intended recipient of the message and the action requested are intertwined in the same procedure. In addition, the SIP security architecture enables verification based on these high level names.

However, there are two essential differences between the capabilities of SIP and the identified requirements for a communication with Networked Appliances. First, SIP location information is in the form of a URL, which is an Internet Domain Name Server (DNS) address. However, not all networked appliances have an IP address (e.g., an X.10 device behind an appliance controller). Second, the only action that the SIP INVITE message can perform is to set up a session with associated bearers, using SDP (or some other MIME TYPE, e.g., ISUP/QSIG). Thus, it can set up a video conference, but INVITE is not designed to transmit messages that control a device.

Also, prior Networked Appliance systems have not provided security for access from outside the home, events and media streaming. Thus, it would be advantageous if SIP or some other system could be adapted to transmit messages that control a device.

In co-pending commonly assigned patent application Ser. No. ______ (Attorney Docket APP 1357) filed concurrently herewith, a method of modifying SIP to overcome these problems is disclosed. In particular, a new method called DO, i.e., a new MIME type and addressing scheme was created and applied to SIP in order to allow command and query communications with Networked Appliances using the SIP format. Further, methods called SUBSCRIBE and NOTIFY, which were created by others for Instant Messaging as extension to SIP, are used in the other application in order to send control messages to Networked Appliances and to receive status information from them. This other application is incorporated herein in its entirety.

### SUMMARY OF THE INVENTION

The present invention is directed to improvements in Session Initiation Protocol in general and to the remote control of Networked Appliances using a modified SIP network in particular.

In a preferred embodiment of the present invention certain functions are moved from SIP User Agents to SIP Proxy servers (either network-based or gateway-based). These functions include address mapping, authentication, authorization and translation. As a result, the processing and memory storage requirements at the agent servers is reduced, creating an overall savings in computing requirements for remote devices. This requires that the access control information for each UAS be provided in the SIP Proxy server. If the SIP messages are end-to-end encrypted from the UAC to the UAS, then either: (1) the messages must be encrypted with the Proxy's encryption key and the UAS must provide the Proxy with its encryption key or (2) the UAS must decrypt the message and send it back to the Proxy for authentication and authorization. The transmission of the Proxy's encryption key can be accomplished with a SIP REGISTER message. After the Proxy server performs the authentication and authorization it will only forward the message to the UAS if the authorization succeeds.

In addition to moving the authentication and authorization functions to the Proxy, when using the invention for Networked Appliances, the address mapping function is also moved to the Proxy server when SIP is used for the control of Networked Appliances. As a result, the UAS only needs to recognize its address and does not need to map the address further. If the message is not meant for it, it will not receive it and the Proxy server will send it to the correct destination. Further, the protocol translation function is also moved from the UASs to the Proxy servers in a similar manner.

### BRIEF DESCRIPTION OF THE DRAWINGS

The foregoing and other features of the present invention will be more readily apparent from the following detailed description and drawings of an illustrative embodiment of the invention in which:

FIG. 1 is an illustration of a prior art SIP architecture;

FIG. 2 is an illustrative embodiment of the SIP architecture modified to accomplish communication with a home Networked Appliance system according to the present invention;

FIG. 3 shows a functional network architecture showing UAS devices which cannot directly communicate with each other; and

FIG. 4 is an illustration of a SIP Networked Appliance system in which authentication, authorization, address mapping and protocol translation have been outsourced to a SIP Proxy server, according to a further aspect of the invention.

### DESCRIPTION OF ILLUSTRATIVE EXEMPLARY EMBODIMENTS

According to the present invention SIP is to be used as the basic architecture to implement remote appliance control. However, before it can be used for this purpose, certain changes must be made. In particular, in SIP, the names that are found in the “To:” and “From:” fields are encoded as Universal Resource Locators (URL). Current implementations support SIP and PHONE URLs. However, a new type of URL must be defined for Networked Appliance systems without changing the nature of the protocol. This new URL type allows for “user friendly” discovery of the appliance address. An example, using the service URL syntax defined in RFC2609; but, without the location information (which has already been determined via the SIP routing) and without the “sip:” prefix would be:

d=lamp,r=bedroom

By base64 encoding this URL (and potentially encrypting it to avoid revealing information about the types of devices contained in the domain) it is possible to structure this URL as part of a SIP URL;

sip:a458fauzu3k3z@stan.home.net

Thus, the existing structure of <entity>@<location> is maintained even when extended to accommodate appliances.

SIP was initially created with call set-up in mind. It is designed for establishing a relationship, or session, between two endpoints such that ongoing bearer paths can be established between them. This structure could be generalized for ‘short-lived’ connections if the connection establishment phase of SIP were removed and the SIP payload generalized. The difference between the current way in which SIP is used and the modifications according to the invention is analogous in many ways to the difference between TCP and UDP or other Session/Datagram protocols.

A new method is being defined as part of the initiative to use SIP for Instant Messaging. This method, called DO meets the requirements for Networked Appliance systems and can carry payloads other than Session Description Protocol (SDP), which is the typical MIME payload for the SIP INVITE messages. Unlike standard SIP bodies or payloads that carry communications information, the DO type contains control and query commands specific for directing and receiving status information from Networked Appliances. Any MIME type could be used as the payload of a SIP command and new MIME types could easily be defined for commands or queries (Action Languages) for a particular class of Networked Appliances. An example of this new MIME type is the Device Messaging Protocol (DMP). DMP is an XML-based specification similar to Universal Plug 'n Play's Device Control Protocol. See, UPnP Device Control Protocol, www.upnp.org. Thus, a DO message would carry the command that is appropriate for the target appliance, such as “Turn The Light On,” or a query, such as “What is the temperature.” The command would trigger a single response, indicative of its result, which would be carried by the standard SIP response mechanisms.

In addition, when a device registers with a Proxy (via the REGISTER message) a description of that device must be conveyed. This is achieved with a Device Description Protocol (DDP) to carry this information. Like the DMP, it is XML-based.

The request URI of the DO type request is a normal SIP URL identifying the party to whom the message is directed. There is no need to established a session or connection ahead of time, as may be the case with conventional SIP. The sender places the URL for the desired recipient in the mandatory “To” field. The “From” field identifies the originator of the message. The message must also contain a Call-ID. In SIP, the Call-ID is used to associated a group of requests with the same session.

Each message contains a Cseq, which is a sequence number plus the name of the method of the request. The Cseq uniquely identifies each message in the session, and increases for each subsequent message. Each DO type also carries a “Via header.” Via headers contain a trace of the IP addresses or FQDNs of the system that the request traversed. As a request travels from proxy to proxy toward the recipient, each adds its address, “pushing” them into a header, much like the operation of a stack. The stack of addresses is reflected in the response, and each proxy “pops” the top address off, and uses that to determine where to send the response. Clients using the DO extension must insert a “Contact” header into the request (Contact is used for routing of requests in the reverse direction, from the target of the original message to the initiator of the original message). The message also contains a body. The body contains the message to be rendered by the recipient. SIP uses the standard MIME headers (Content-Type, Content-Length, and Content-Encoding) to identify the content. The request may be sent using UDP or TCP or SCTP transport. Reliability is guaranteed over UDP and congestion control is provided through a simple retransmission.

The SIP DO type has the following format and nine parts:

DO sip: user2@domain.com SIP/2.0

(1) Via:[SIP/2.0/UPD user1pc.domain.com],

(2) From:[sip:user1@domain.com],

(3) To:[sip: user2@domain.com],

(4) Contact:[sip: user1@user1pc.domain.com],

(5) Call-ID:[asd88asd77a@1.2.3.4],

(6) Cseq:[1 MESSAGE]

(7) Content-Type:[text/plain],

(8) Content-Length:[18], and

(9) Body [e.g., “Watson, come here.”].

The portions in square brackets indicate examples of content.

This structure establishes synchronous communication with Networked Appliances. However, it is also necessary to establish asynchronous communications. For example, in order to be notified when an alarm goes off in your home, a certain temperature is reached, or when someone rings your doorbell, the system must be capable of asynchronous communication.

The SIP Instant Messaging system defines two new primitives, SUBSCRIBE and NOTIFY that can be used to achieve asynchronous communications. When these two methods are used in conjunction with the proposed addressing scheme and the Device Messaging Protocol MIME type, then event notification from and between Networked Appliances is enabled.

Further details of the modification of SIP to handle Networked Appliances is set forth in the above-identified co-pending application which is incorporated herein by reference.

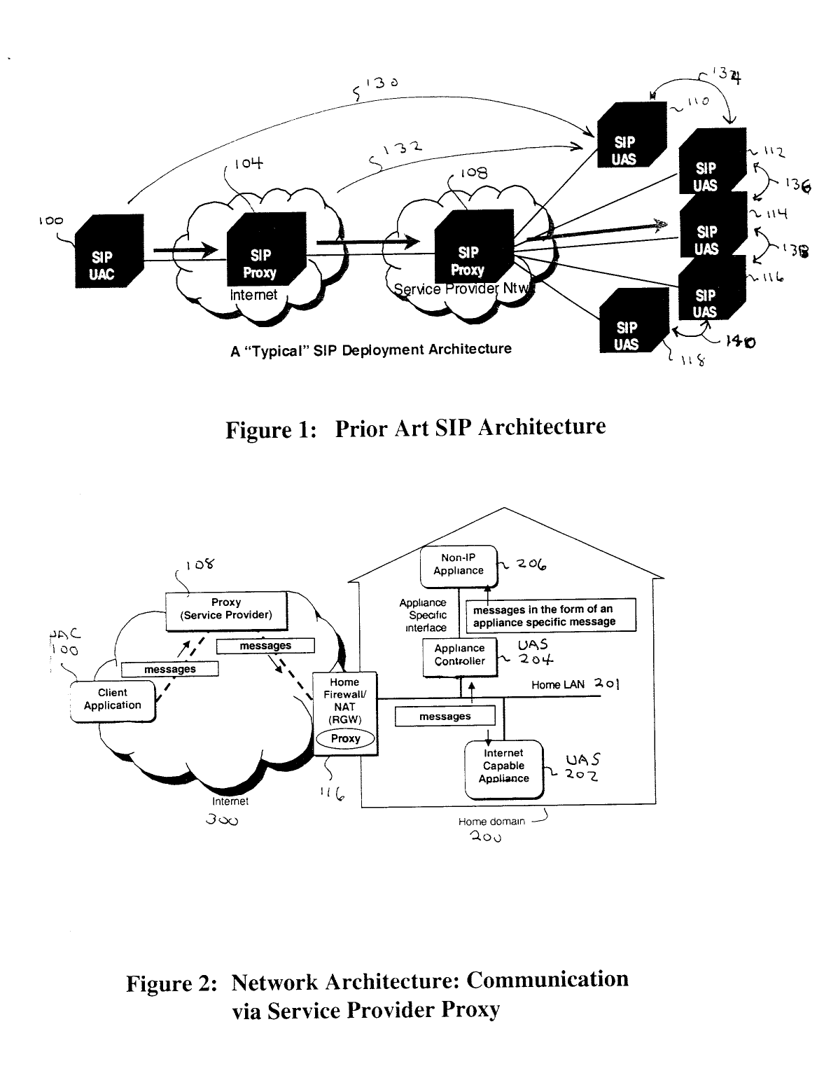

FIG. 1 shows a typical prior art SIP architecture. In this arrangement, a client, e.g., an Internet phone user, employs a SIP User Agent application operating as a client, i.e., SIP UAC 100, to initiate a SIP communication with one or more User Agent Servers (UAS) which may be associated with an intended recipient of an Internet phone call. This system supports three different types of architectures which permit remote communication with networked devices. The actual implementations may use any combination of the three architectures.

In the first arrangement, the client application UAC 100 is able to directly connect to and interact with one of several UAS devices 110, 112, 114, 116 and 118. In this case the client establishes contact directly with the UAS 110 at the recipient via path 130. The second architecture has the client application interact with a SIP proxy 104 in the Internet in order to communicate with networked devices, e.g., Internet phones. In the second architecture, another SIP proxy 104 passes communications from UAC 100 to one of the various SIP UAS devices, e.g. UAS 110, via path 132.

With the third arrangement, the conventional SIP message or request is first routed from UAC 100 to the Internet SIP Proxy server 104, which processes it and sends it to the SIP Proxy server 108. This Proxy 108 then sends the request to one of the several UASs 110, 112, 114, 116, 118 associated with it. Each of the UASs may be at separate locations, e.g., at the homes of individuals selected to receive the messages, and are embedded in or attached to devices, such as a telephone instrument. Assuming the request is for the home associated with SIP UAS 116, the message is delivered to it and the device attached to it. Based on the message, UAS 116 operates the device according to the message. As shown by arrows or paths 134, 136, 138, 140, each of the UAS devices can communicate directly with each other.

Before the UAS 116 processes the message and sends the instruction to the device, it must determine that the message was intended for it, and it was sent by an authorized individual. Thus, UAS 116, and all of the other UASs, must check the destination address of the messages, and make sure that the messages are authorized and are in a format it can interpret. Further, the UAS must be able to translate the message into a format that the attached device can understand and respond to.

If the SIP protocol is extended as suggested above to include DO, SUBSCRIBE and NOTIFY methods, the various SIP architectures can be used to communicate with Networked Appliances. The architecture of such a system is shown in FIG. 2. It allows a client application to interact with Networked Appliances in the home domain 200. The wide area network 300, e.g. the Internet, is used to carry messages from a client application at SIP UAC 100 to an external proxy 108 (e.g., in the Networked Appliance Service Provider's network). This proxy is in communications with a number of residential gateways (RGW) in the form of a Home Firewall/Network Address Translator (NAT). Each containing a proxy server 116, which may be a UAS or lead to other UAS devices. Once authenticated, these messages are allowed through the firewall. Inside the home domain 200, messages are transported over the Home LAN 201 to the appropriate Networked Appliance. The devices may either be “IP capable”, i.e., they can process the incoming SIP messages themselves, such as device 202, or Non-IP-capable appliances, such as appliance 206. Non-IP-capable appliances require an appliance controller 204 to translate the SIP control requests to the specific protocol of the appliance.

All communications between the Proxy server and the Home Firewall/NAT are assumed to be secure. In the case shown in FIG. 2 the Proxy server is physically located in the home domain's gateway device 116. This Proxy server can provide a number of functions including:

Authentication and authorization of each message/request.

Address mapping/resolution for Networked Appliances within the home domain.

Security for the Home Firewall/NAT (RGW) for communications to the outside world.

Networked Appliance mobility and tracking service.

Message protocol mapping for client applications. By taking this approach, a variety of client applications can be supported for remote controlling Networked Appliances.

A charging point for services.

When the proxy is in the gateway device, it requires a lot of functionality, which may place onerous requirements on the gateway device in terms of performance, memory, etc. Since gateway devices may not have the resources required to support the proxy functionality previously described, much of the functionality could be moved to the service provider proxy. If a secure connection (e.g., IPsec tunnel) existed between the external proxy 108 and the gateway proxy 116′, the gateway proxy would only be required to forward the SIP messages to the appropriate UA. The split of functionality in the gateway proxy does not have to be an “all or nothing” decision, but could be split equally (or unequally) between the two proxies. The advantages of this approach are:

Administration of the SIP Proxy is performed centrally, avoiding a distributed systems issue.

If the local link to the home were to fail, functionality would still be available through the Service Provider Proxy 108 from the wide area 300, e.g. so the system could re-direct messages to another home, for example.

Configuration of the RGW is kept to a minimum, although it may still be necessary to perform some limited configuration such as the creation of an IPsec tunnel.

The costs of making the Service Provider fault tolerant can be amortized across multiple homes.

In the arrangement of FIG. 2 the SIP UAS (as shown in FIG. 1) is considered to be the residential gateway (RGW). However, in an alternative embodiment, the internet capable appliance 202 and the appliance controller 204 may be considered SIP UAS devices, with the RGW as their proxy server. However, in the arrangement the UAS device would not need address mapping capability, unless for example the controller 204 controlled more than one appliance.

The SIP architecture, even as modified as suggested in the above-identified co-pending application, has some shortcomings when applied to Networked Appliances. In particular, the current SIP architecture has the SIP UAS perform the functions of authentication and authorization, address checking and mapping, and protocol translation, if necessary. The problem with this is that agents are deployed in small, embedded devices with limited resources for processing and memory storage. In addition, since the agents are distributed, the management and administration of these functions is difficult and has to be repeated in each agent.

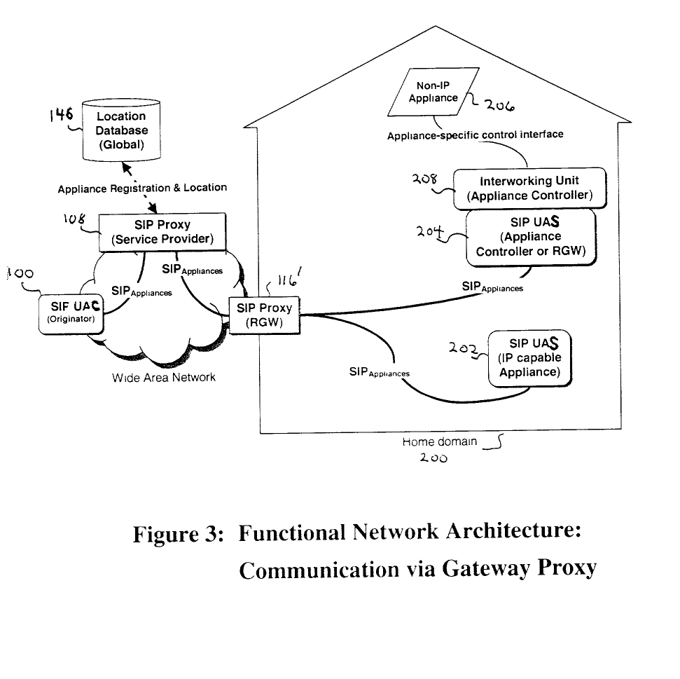

As shown in FIG. 2, a Networked Appliances system is implemented in which a client, i.e., a homeowner, remotely controls appliances in his home by transmitting control signals to the home over the Internet using a Session Initiation Protocol (SIP) architecture. All control communications from outside the home domain 100 to any appliance within that domain must pass through the service provider proxy 108. However, the appliances in the form of UAS devices in the home domain as shown in FIG. 1 and FIG. 2 can communicate with each other over the Home LAN 201. However, the system according to the present invention differs from the prior art SIP system shown in FIGS. 1 and 2 in that the communications paths between UAS 110-118 (i.e., paths 134-140) have been eliminated. Thus, all UAS communications between UAS devices within the home domain 100 must go through home Proxy server 116′ as shown in FIG. 3. All communications with these UAS devices from outside the home domain must be through the service proxy 108. In addition, in FIG. 3 the authentication and authorization functions have been moved from the UASs to Proxy server 116′ or the service provider proxy server 108. This requires the access control information for each UAS to be located in the SIP Proxy server 116′ or 108.

FIG. 3 is a functional representation of the SIP Architecture for supporting Networked Appliances as modified according to the present invention. It is based on the Messaging via Proxy architecture. In FIG. 3 a request for operation of a Networked Appliance or the status thereof, begins in an originating client application at SIP UAC 100 (originating application). SIP UAC 100 is used by the originating application to generate and send appliance messages (DO) to the SIP Proxy 108 hosted by either the service provider or the home RGW. The SIP proxy 108 in the service provider domain resolves the address of the appliance to be communicated with (including the appropriate Home domain RGW) by means of a lookup in a location database 146. The SIP Proxy forwards appliance messages from the Client SIP UA 100 to the SIP Proxy 116′ in the Home Domain RGW or, via a secure connection, directly to the SIP UAS in the target device.

The location database 146 contains location information for all registered appliances within the home domains. This database is populated with information gathered by the service provider SIP Proxy 108 during a registration procedure. In particular, REGISTER messages are sent to Proxy 108 to register the location of the client and each appliance. In the case of appliances, the registration may merely be that the appliance is in home domain 200. Further, even this may not be registered, only the IP address of home domain 200. In this case the user is expected to know which appliances are available in his home domain. A message addressed to a specific appliance in that domain will be routed to the appliance by address mapping in the proxy. In the prior art, this was done in Proxy 116′. However, according to the present invention, it is accomplished in Proxy 108. While not shown, Proxy 108 is connected to a plurality of UAS devices 116′ which control various home domains 200.

The SIP Proxy 116′ (which is operating as a UAS) in the home domain residential gateway provides the gateway between Appliances in the home domain and entities in the wide area. Other RGW functions, such as Firewall and NAT, may be co-located with the RGW SIP Proxy 116′. A SIP appliance or appliance controller terminates SIP appliance messages from the originating application SIP UAC 100. However, the addressing information for these devices is mapped in the Proxy 108. In the case of non-IP appliance 108, the messaging information from the SIP message passes through device 116′ to the line leading to controller 204 and is passed to the Interworking Unit 208. The Interworking Unit 206 will translate the appliance message into a form useable by the appliance and convert status information from the appliance into a form usable by the network. However, the translation of the appliance message in the language of the appliance can also be achieved in Proxy 108. Thus, the Interworking Unit 208 may be eliminated according to the invention, except perhaps for providing status information from the appliance.

The IP-capable appliance 202 also terminates SIP appliance control messages from the originating application SIP UAC 100, and retrieves the appliance control status information for the appliance application, acting on it directly without any requirement for an intervening Interworking Unit 206 or an appliance controller 204 which may be needed for the non-IP appliance.

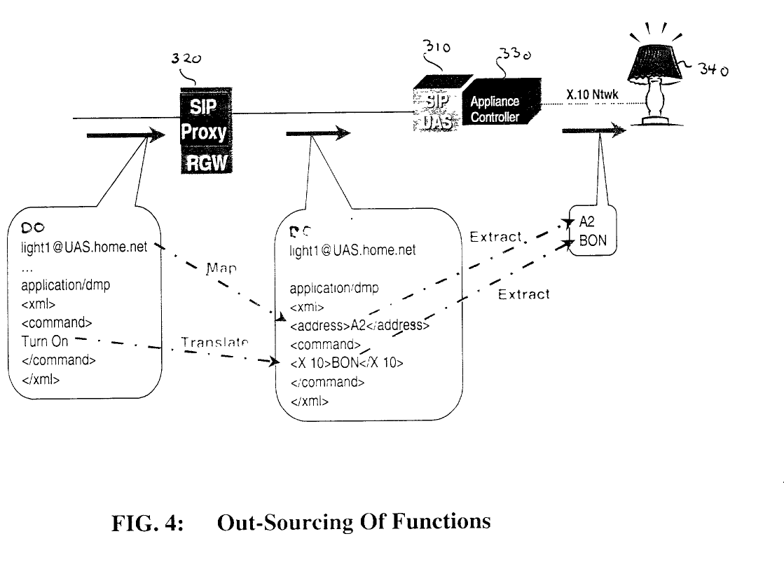

FIG. 4 is a functional representation of the out-sourcing of the authentication, authorization, translation and address mapping functions from the UAS devices to the Service Provider Proxy 108. In particular, when a message is sent to a particular UAS 310, the Proxy 320 makes sure it is from an authentic source, e.g., the home owner. This can be by means of a password, which instead of being stored in the UAS, is stored in the Proxy and is checked by it. Even if the source is authentic, the requested action may not be one authorized to that individual. For example, a parent may be authorized to control any function, but may set up the system so that a child may only be authorized to turn on the lights, but not to adjust to heat. Thus, the Proxy checks the message from the authorized individual to see if that individual has the authority to control the device in question. The computation power needed to perform this function has now been moved to the Proxy 320 from the UAS 310. As a result, the UASs may be made smaller, consume less power, need less memory and less computing power. As a result, a proliferation of UASs does not unduly burden the system, since these functions for the UASs can be performed efficiently in the Proxy.

If the Proxy determines that the authentication and authorization are correct, the control message is then sent on to the UAS 310. The message is then delivered by UAS 310 to appliance controller 330, which can then perform the requested operation, i.e., turn on the lamp 340.

Further, as also shown in FIG. 4, in addition to the authentication and authorization functions, the address mapping and protocol translation functions are also relocated from the UAS 310 to the Proxy server 320. For a SIP Proxy to perform this address mapping and protocol translation it will require: (1) an address mapping table—which can be populated for each device using SIP REGISTER messages and (2) translation “rules” for each type of device protocol—which needs to be “provisioned” ahead of time. In particular, when a device issues a REGISTER message to the SIP Proxy it will have to include (in the payload of the message using the Device Description Protocol MIME type): (1) a description of the type of device protocol it uses and (2) the physical device address.

The external address for the message, e.g., “light1@UAS.home.net” is translated into the in home LAN address A2 by the Proxy 320, so the UAS 310 does not need to do it. Further, the command “Turn On” is translated into the X.10 code BON which the appliance controller 330 understands and can respond to.

With this arrangement, instead of having to perform address translation and protocol mapping, the UAS 310 only has to extract (i.e. parse) the address and protocol message from the message sent to the UAS from the SIP Proxy. Parsing is a much more lightweight operation than address mapping and protocol translation.

In previous solutions, all of the functionality had to be placed in the endpoint device. This means that every endpoint had to have sufficient processing capability to be able to perform all processing necessary, even though the utilization may be very low. The present invention allows statistical multiplexing of resources across a large number of endpoints, thus resulting in an overall cost saving. Further, there are also market possibilities which become available with this technique. Increased reliance on certain network infrastructure means that a user (customer, homeowner, etc.) is more likely to be locked in to this provider. This is preferable from the perspective of the network owner.

In addition, this arrangement also provides a point in the network where usage and charging/billing records can be collected. Based on this approach, it is possible to bill flat rate for control of some commodity appliances (e.g., lamps, refrigerators), but charge for control of other (premium) devices (e.g., high-end TVs, DVD players).

The present invention differs from some basic concepts of the prior art SIP architecture. The invention involves some configuration of the SIP endpoints so that they will always communicate via the service provider proxy, as opposed to communicating directly with each other. This change enables the service provider to control access and provide value-add services to the home network.

As illustrated above, the present invention is applicable to Networked Appliances. However the out-sourcing of authentication and authorization elements is also applicable to SIP for Voice over IP, SIP for Instant Messaging, and SIP for other services. Further this functionality may be used for media translation performed by proxies, e.g., text messages translated to audio and/or audio messages translated to text. It can also be incorporated into Call Agent/Softswitch products (like those sold by Telcordia) that also support the SIP protocol.

SIP, with the newly proposed DO, SUBSCRIBE, and NOTIFY messages, plus the new MIME types, and new mechanism for encoding service information in the “To:” field can provide the support necessary for communication with Networked Appliances from a wide area network. This enables leveraging the existing SIP infrastructure and capabilities (e.g., hop-by-hop routing and security) for a new problem domain—Networked Appliances. Further, the out-sourcing of some UAS functions to Proxies allows the system to be more cost effective and provides additional marketing opportunities for system owners.

While the invention has been particularly shown and described with reference to a preferred embodiment thereof, it will be understood by those skilled in the art that various changes in form and details may be made therein without departing from the spirit and scope of the invention.

We claim:

1. A session initiation protocol (SIP) system for communications between a client and at least one networked appliance, comprising:
a user agent server (UAS) processor connected to said appliance so as to relay commands to said appliance and receive status information from said appliance;
a user agent client (UAC) processor having the capacity to send SIP command messages intended for said appliance to said UAS processor over a communications network and to receive over the communications network status information messages about said appliance from said UAS processor, said UAS processor translating received SIP commands into commands recognized by the appliance and translating information provided by said appliance into SIP status messages for transmission over the communications network to said UAC processor; and
a network appliance system proxy server (Proxy) located between the UAC and the UAS for receiving and conveying information between them; and
wherein the UAS processor does use address mapping capability for handling at least some of the messages to and from the appliances; and
wherein Proxy has address mapping capability to direct said at least some messages through the appropriate UAS processor to the appliance to which they are addressed.

2. A session initiation protocol (SIP) system for communications between a client and at least one networked appliance, comprising:
a user agent server (UAS) processor connected to said appliance so as to relay commands to said appliance and receive status information from said appliance;
a user agent client (UAC) processor having the capacity to send SIP command messages intended for said appliance to said UAS processor over a communications network and to receive status information messages over the communications network about said appliance from said UAS processor, said UAS processor translating received SIP commands into commands recognized by the appliance and translating information provided by said appliance into SIP status messages for transmission over the communications network to said UAC processor; and
a network appliance system proxy server (Proxy) located between the UAC and the UAS for receiving and conveying information between them; and
wherein the UAS processors do not use at least some message authentication capabilities; and
wherein the Proxy has authentication capabilities for the appliances connected to the UAS processors which are in turn connected to the Proxy, said authentication capabilities acting to assure that the message directed to an appliance is from an authorized client.

3. The session initiation protocol (SIP) system of claim 1, wherein the UAS processors do not use at least some message authentication capabilities and the Proxy has authentication capabilities for the appliances connected by the UAS servers to the Proxy, said authentication capabilities acting to assure that the message directed to an appliance is from an authentic client.

4. The session initiation protocol (SIP) system of claim 1, wherein the UAS processors do not use at least some message authorization capabilities and the proxy server has authorization capabilities for the appliances connected by the UAS servers to the Proxy, said authorization capabilities acting to assure that a command in the message directed to an appliance is within the client's authority.

5. The session initiation protocol (SIP) system of claim 1, wherein the UAS processors do not use at least some message translation capabilities and the Proxy has translation capabilities for the appliances connected by the UAS servers to the Proxy, said translation capabilities acting to assure that a command in the message directed to an appliance is in a form that the appliance can interpret.

6. The session initiation protocol (SIP) system of claim 2, wherein the UAS processors do not use at least some address mapping capabilities and the Proxy has address mapping capabilities for the appliances connected by the UAS servers to the Proxy, said address mapping capabilities acting to assure that a message is directed to the appropriate appliance.

7. The session initiation protocol (SIP) system of claim 2, wherein the UAS processors do use at least some translation capabilities and the Proxy has translation capabilities for the appliances connected by the UAS servers to the Proxy, said translation capabilities acting to assure that a command in the message directed to an appliance is in a form that the appliance can interpret.

8. The session initiation protocol (SIP) system of claim 2, further including an appliance controller located between said UAS processor and said appliance, said controller translating commands from said Proxy into signals which control operation of said appliance and translating status signals from said appliance into signals which can be interpreted by said Proxy.

9. The session initiation protocol (SIP) system of claim 2, wherein there are a plurality of appliances in one geographic location that are networked to a single UAS processor, the command message identifies the appliance to which the message is addressed, and the Proxy directs the message to the proper UAS processor coded to reach the proper appliance for which it is intended.

10. The session initiation protocol (SIP) system of claim 9, wherein the status information from each of the plurality of appliances identifies the appliance from which it originated, and the Proxy includes an identification of the appliance in the status messages sent to said UAC.

11. A method for communications between a client and at least one networked appliance using session initiated protocol (SIP), comprising the steps of:
using a user agent client (UAC) processor to send SIP command messages intended for said appliance over a communications network to a Proxy server;
receiving the command message in the Proxy server;
using address mapping capability in said Proxy server to direct at least some messages to a user agent server (UAS) processor associated with said appliance;
receiving a message from said Proxy server at the UAS processor associated with said appliance; and
using said UAS processor to translating received SIP commands into commands recognized by the appliance.

12. A method for communications between a client and at least one networked appliance as set forth in claim 11, where in the command is a query and further including the steps of:
receiving at the UAS processor from the appliance status information;
using said UAS processor to translate the status information into SIP protocol;
transmitting the UAS status information in SIP protocol to said UAC processor via said Proxy; and
displaying the status information at the UAC processor.

13. A method for communications between a client and at least one networked appliance using session initiated protocol (SIP), comprising the steps of:
using a user agent client (UAC) processor to send SIP command messages intended for said appliance over a communications network to a Proxy server;
receiving the command message in the Proxy server;
using authentication capability in said Proxy server to assure that the message directed to an appliance is from an a authentic client;
receiving a message from said Proxy server at the UAS processor associated with said appliance; and
using said UAS processor to translating received SIP commands into commands recognized by the appliance.

14. A method for communications between a client and at least one networked appliance using session initiated protocol (SIP), comprising the steps of:
using a user agent client (UAC) processor to send SIP command messages intended for said appliance over a communications network to a Proxy server;
receiving the command message in the Proxy server;
using authorization capability in said Proxy server to assure that the message directed to an appliance is contains commands authorized for the client;
receiving only authorized messages from said Proxy server at the UAS processor associated with said appliance; and
using said UAS processor to translating received SIP commands into commands recognized by the appliance.

15. A method for communications between a client and at least one networked appliance using session initiated protocol (SIP), comprising the steps of:
using a user agent client (UAC) processor to send SIP command messages intended for said appliance over a communications network to a Proxy server;
receiving the command message in the Proxy server;
using translation capability in said Proxy server to assure that a command in the message directed to an appliance is in a form that the appliance can interpret;
receiving a message from said Proxy server at the UAS processor associated with said appliance; and
using said UAS processor to translating received SIP commands into commands recognized by the appliance.

16. A method for communications between a client and at least one networked appliance as in claim 15, wherein said Proxy server is at least a first and second Proxy server connected in series and a portion of any one of address mapping, authentication, authorization and translation functions are out-sourced from the UAS processors to at least in part to at least one of the first and second Proxy servers.
